(19) United States
(12) Patent Application Publication
(10) Pub. No.: US 2020/0328693 A1
(43) Pub. Date: Oct. 15, 2020

(54) CONVERTER CIRCUIT, POWER CONVERSION SYSTEM, AND MOTOR DRIVE APPARATUS

(71) Applicant: FANUC CORPORATION, Yamanashi (JP)

(72) Inventor: Shouta FUJII, Yamanashi (JP)

(21) Appl. No.: 16/846,405

(22) Filed: Apr. 13, 2020

(30) Foreign Application Priority Data
Apr. 15, 2019 (JP) 2019-077373

(51) Int. Cl. H02M 7/155; H02P 6/08

(52) U.S. Cl. CPC H02M 7/1557; H02M 7/06; H02P 6/085

(57) ABSTRACT

A converter circuit for converting an AC voltage input from a polyphase AC power supply into a DC voltage and outputting the DC voltage includes a positive DC terminal and a negative DC terminal configured to output the DC voltage, diodes each having its anode electrically connected to a corresponding phase of the polyphase AC power supply, and all having their cathodes electrically connected to the positive DC terminal, and a connection portion electrically connecting a neutral point of the polyphase AC power supply and the negative DC terminal to each other.

### BACKGROUND OF THE INVENTION

### 1. Field of the Invention

The present invention relates to a converter circuit, a power conversion system, and a motor drive apparatus.

### 2. Description of the Related Art

In a motor drive apparatus for driving AC motors in a machine tool, forging machinery, an injection molding machine, industrial machinery, or various robots, an AC voltage input from an AC power supply is temporarily converted into a DC voltage, the DC voltage is further converted into an AC voltage, and the AC voltage is applied to and drives the AC motors. Therefore, the motor drive apparatus includes a power conversion system including a converter circuit that rectifies an AC voltage output from an AC power supply into a DC voltage, and an inverter circuit that converts the DC voltage output from the converter circuit into an AC voltage.

As disclosed in, e.g., Japanese Unexamined Patent Publication No. 2000-228883, a power conversion apparatus is known in which three conversion units each including a DC power supply unit that is insulated from a common AC power supply through an input transformer and rectifies a secondary output voltage of the input transformer, and a single-phase three-level inverter that receives, as input, a DC voltage output from the DC power supply unit are connected in parallel between the AC power supply and a load, and each of the three single-phase three-level inverters has one output terminal connected commonly, and the other output terminal connected to the load in a star configuration.

As disclosed in, e.g., Japanese Unexamined Patent Publication No. 2001-268922, a power conversion apparatus including a three-phase PWM inverter including a converter unit that performs AC-to-DC conversion and a neutral point dividing a converter unit output voltage, the three-phase PWM inverter outputting a variable-voltage, variable-frequency voltage by pulse width modulation, a motor, and a common mode reactor connected in series between the three-phase PWM inverter and the motor is known to include fourth winding wound on an iron core identical to an iron core on which the common mode reactor is wound, and an inductor having one end connected to an output of the three-phase PWM inverter, and the other end serving as another neutral point and connected to one end of the fourth winding by star connection, wherein the other end of the fourth winding is connected to the neutral point dividing the converter output voltage, or a positive side or a negative side of a converter output.

As disclosed in, e.g., Japanese Unexamined Patent Publication No. 2018-153001, a power conversion apparatus is known to include a first power conversion circuit, a first grounded circuit electrically connected to a DC side of the first power conversion circuit in the apparatus, and a second grounded circuit electrically connected to an AC side of the first power conversion circuit in the apparatus, wherein the first grounded circuit and the second grounded circuit are electrically connected to each other.

### SUMMARY OF INVENTION

In a power conversion system including a converter circuit and an inverter circuit, a DC voltage equal to or lower than an input rated voltage is to be desirably input to the inverter circuit. For example, a converter circuit serving as a diode rectifier circuit outputs a DC voltage that depends on the magnitude of an AC voltage input from an AC power supply. As another example, in a converter circuit serving as a PWM switching control rectifier circuit, the voltage of the converter circuit on the DC output side may be preferably always boosted to be equal to or higher than the peak value of an AC voltage input from an AC power supply. Therefore, depending on the magnitude of the AC voltage of the AC power supply, some kind of adjustment may be preferably performed for the DC output voltage of the converter circuit to set the DC voltage input to the inverter circuit to an input rated voltage or less. It is a common practice, for example, to place a transformer on the AC input side of a converter circuit and transform an AC voltage input to the converter circuit to step down the DC output voltage of the converter circuit to be equal to or lower than the input rated voltage of an inverter circuit. It is another common practice to place a DC/DC converter circuit (that is different from a converter circuit serving as a rectifier circuit) on the DC output side of a converter circuit and lower the DC output voltage of the converter circuit by the DC/DC converter circuit to obtain a voltage equal to or lower than the input rated voltage of an inverter circuit. Since the AC power supply voltage differs in each country or region, adjustment using a transformer or a DC/DC converter circuit, as described above, is widely performed to use power conversion systems mass-produced based on certain standards. The transformer and the DC/DC converter circuit, however, are physically large, have complicated circuitry, and naturally entail high costs. Therefore, a demand has arisen for a compact, low-cost converter circuit having a simple structure, in a power conversion system including a converter circuit and an inverter circuit and used for a motor drive apparatus.

According to one aspect of the present disclosure, a converter circuit for converting an alternating-current voltage input from a polyphase (multi-phase) alternating-current power supply into a direct-current voltage and outputting the direct-current voltage includes a positive direct-current terminal and a negative direct-current terminal configured to output the direct-current voltage, a plurality of diodes each having an anode electrically connected to a corresponding phase of the polyphase alternating-current power supply, and all having cathodes electrically connected to the positive direct-current terminal, and a connection portion electrically connecting a neutral point of the polyphase alternating-current power supply and the negative direct-current terminal to each other.

### BRIEF DESCRIPTION OF THE DRAWINGS

The present invention will be more clearly understood with reference to the following accompanying drawings:

FIG. 1 is a block diagram depicting a converter circuit, a power conversion system, and a motor drive apparatus according to a first embodiment of the present disclosure;

FIG. 2 is a graph representing the relationship between the line voltages and the phase voltages of a polyphase AC power supply;

FIG. 3 is a circuit diagram for explaining the relationship between the AC input voltage and the DC output voltage in the converter circuit according to the first embodiment of the present disclosure;

FIG. 4 is a graph illustrating an exemplary relationship between the DC output voltage of the converter circuit and the phase voltages of the polyphase AC power supply according to the first embodiment of the present disclosure;

FIG. 5 is a circuit diagram for explaining the relationship between the AC input current and the DC output current in the converter circuit according to the first embodiment of the present disclosure;

FIG. 6A is a chart illustrating an exemplary relationship between the DC output current waveform of the converter circuit and the AC input current waveform of the polyphase AC power supply according to the first embodiment of the present disclosure;

FIG. 6B is a chart illustrating the details of FIG. 6A as enlarged in the direction of current;

FIG. 7 is a block diagram depicting a motor drive apparatus according to a conventional example including a transformer;

FIG. 8 is a block diagram depicting a motor drive apparatus according to another conventional example including a DC/DC converter circuit;

FIG. 9 is a block diagram depicting a converter circuit, a power conversion system, and a motor drive apparatus according to a second embodiment of the present disclosure;

FIG. 10 is a block diagram depicting a converter circuit, a power conversion system, and a motor drive apparatus according to a third embodiment of the present disclosure;

FIG. 11 is a block diagram depicting a converter circuit, a power conversion system, and a motor drive apparatus according to a fourth embodiment of the present disclosure;

FIG. 12A is a chart illustrating an exemplary relationship between the DC output current waveform of the converter circuit and the AC input current waveform of the polyphase AC power supply according to the third embodiment of the present disclosure;

FIG. 12B is a chart illustrating the details of FIG. 12A as enlarged in the direction of current;

FIG. 13 is a block diagram depicting a converter circuit, a power conversion system, and a motor drive apparatus according to a fifth embodiment of the present disclosure;

FIG. 14A is a chart representing the relationship between the waveforms of AC currents and ON and OFF commands issued by a control unit during power running and regeneration of the converter circuit in the fifth embodiment of the present disclosure, and depicts the waveforms of AC currents input to the converter circuit or output from the converter circuit;

FIG. 14B is a chart representing the relationship between the waveforms of the AC currents and the ON and OFF commands issued by the control unit during power running and regeneration of the converter circuit in the fifth embodiment of the present disclosure, and depicts the ON and OFF commands issued by the control unit;

FIG. 15A is a chart representing the waveforms of an AC current and an AC voltage on the AC side of the converter circuit during power running and regeneration of the converter circuit in the fifth embodiment of the present disclosure, and depicts U-phase waveforms;

FIG. 15B is a chart representing the waveforms of another AC current and another AC voltage on the AC side of the converter circuit during power running and regeneration of the converter circuit in the fifth embodiment of the present disclosure, and depicts V-phase waveforms; and

FIG. 15C is a chart representing the waveforms of still another AC current and still another AC voltage on the AC side of the converter circuit during power running and regeneration of the converter circuit in the fifth embodiment of the present disclosure, and depicts W-phase waveforms.

### DETAILED DESCRIPTION

A converter circuit, a power conversion system, and a motor drive apparatus will be described below with reference to the drawings. These drawings use different scales as appropriate to facilitate an understanding. The mode illustrated in each drawing is one example for carrying out the present disclosure, and the present disclosure is not limited to the embodiments illustrated in these drawings.

A converter circuit mounted in a motor drive apparatus will be taken as an example herein, but each embodiment is also applicable when the converter circuit is mounted in a machine other than the motor drive apparatus.

A converter circuit for converting an AC voltage input from a polyphase AC power supply into a DC voltage and outputting the DC voltage according to an embodiment of the present disclosure includes a positive DC terminal and a negative DC terminal for outputting the DC voltage, diodes each having its anode electrically connected to a corresponding phase of the polyphase AC power supply, and all having their cathodes electrically connected to the positive DC terminal, and a connection portion electrically connecting a neutral point of the polyphase AC power supply and the negative DC terminal to each other. Embodiments will be enumerated below.

A converter circuit, a power conversion system, and a motor drive apparatus according to a first embodiment will be described first.

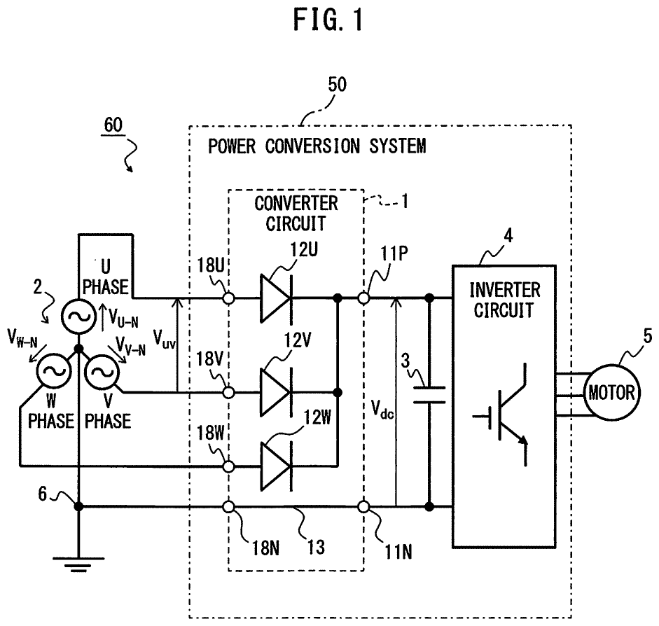

FIG. 1 is a block diagram depicting a converter circuit, a power conversion system, and a motor drive apparatus according to the first embodiment of the present disclosure.

The case where a motor 5 is controlled by a motor drive apparatus 60 connected to a polyphase AC power supply 2 will be taken as an example herein. The type of motor 5 is not particularly limited, and may be implemented as, e.g., an AC motor or a DC motor. When the motor 5 is implemented as a DC motor, no inverter circuit 4 is used. When, as illustrated in FIG. 1, the motor 5 is implemented as an AC motor, it may serve as, e.g., an induction motor or a synchronous motor, and the number of phases of the motor 5 is not limited either. Machines equipped with motors 5 include, e.g., a machine tool, a robot, forging machinery, an injection molding machine, industrial machinery, transport machinery, and various electrical appliances.

The polyphase AC power supply 2 may preferably have three or more phases. In the first embodiment described herein and each embodiment to be described later, the polyphase AC power supply 2 is implemented as a three-phase AC power supply as an example. Examples of the polyphase AC power supply 2 may include a 200-V three-phase AC power supply, a 400-V three-phase AC power supply, and a 600-V three-phase AC power supply. “200 V,” “400 V,” and “600 V” appended to these three-phase AC power supplies indicate their line voltage effective values.

As illustrated in FIG. 1, a converter circuit 1 according to the first embodiment of the present disclosure includes a positive DC terminal 11P and a negative DC terminal 11N, diodes 12U, 12V, and 12W, and a connection portion 13. The converter circuit 1 further includes a U-phase AC terminal 18U, a V-phase AC terminal 18V, a W-phase AC terminal 18W, and a neutral AC terminal 18N.

The positive DC terminal 11P and the negative DC terminal 11N are used to output a DC voltage from the converter circuit 1.

The U-phase AC terminal 18U, the V-phase AC terminal 18V, and the W-phase AC terminal 18W are provided in correspondence with the U, V, and W phases, respectively, of the polyphase AC power supply 2 and used to input (apply) an AC voltage generated by the polyphase AC power supply 2 to the converter circuit 1. The neutral AC terminal 18N is used to input (apply) the potential of a neutral point 6 of the polyphase AC power supply 2 to the converter circuit 1. The U-phase voltage of the polyphase AC power supply 2 implemented as a three-phase AC power supply is represented as V_{U-N}, its V-phase voltage is represented as V_{V-N}, and its W-phase voltage is represented as V_{W-N}.

The diodes 12U, 12V, and 12W each have its anode electrically connected to a corresponding phase of the polyphase AC power supply 2, and all have their cathodes electrically connected to the positive DC terminal 11P. In the example illustrated in FIG. 1, since the polyphase AC power supply 2 is implemented as a three-phase AC power supply, the converter circuit 1 is equipped with three diodes. The first diode 12U has its anode electrically connected to the U phase of the polyphase AC power supply 2 via the U-phase AC terminal 18U, and its cathode electrically connected to the positive DC terminal 11P. The second diode 12V has its anode electrically connected to the V phase of the polyphase AC power supply 2 via the V-phase AC terminal 18V, and its cathode electrically connected to the positive DC terminal 11P. The third diode 12W has its anode electrically connected to the W phase of the polyphase AC power supply 2 via the W-phase AC terminal 18W, and its cathode electrically connected to the positive DC terminal 11P. In this manner, the first diode 12U, the second diode 12V, and the third diode 12W have their anodes directly connected to the respective phases of the polyphase AC power supply 2, and therefore preferably use configurations having withstand voltages higher than the phase voltages of the polyphase AC power supply 2.

The connection portion 13 is implemented as electrical wiring electrically connecting the neutral point 6 of the polyphase AC power supply 2 and the negative DC terminal 11N to each other.

A power conversion system 50 includes the converter circuit 1, a capacitor 3, and an inverter circuit 4.

The capacitor 3 has its positive and negative electrodes electrically connected to the positive DC terminal 11P and the negative DC terminal 11N, respectively, of the converter circuit 1. The capacitor 3 is also called a DC link capacitor or a smoothing capacitor. The capacitor 3 has the function of storing DC power used to generate AC power by the inverter circuit 4, and the function of suppressing pulsation of a DC voltage (DC current) output from the converter circuit 1. Examples of the capacitor 3 may include an electrolytic capacitor and a film capacitor.

The inverter circuit 4 is electrically connected to the converter circuit 1 via the capacitor 3, and converts a DC voltage output from the converter circuit 1 into an AC voltage and outputs the AC voltage. The inverter circuit 4 may preferably have a configuration capable of converting a DC voltage into an AC voltage, and a PWM inverter circuit including internal semiconductor switching elements, for example, is available as the inverter circuit 4. The inverter circuit 4 is embodied as a three-phase bridge circuit when the motor 5 is implemented as a three-phase AC motor, and as a single-phase bridge circuit when the motor 5 is implemented as a single-phase motor. When the inverter circuit 4 is implemented as a PWM inverter circuit, it is embodied as a bridge circuit of semiconductor switching elements and diodes connected in antiparallel with the semiconductor switching elements. In this case, examples of the semiconductor switching element may include an FET, an IGBT, a thyristor, a GTO (Gate Turn-OFF thyristor), SiC (Silicon Carbide), and a transistor, but other types of semiconductor switching elements may be used. When the motor 5 is implemented as a DC motor, no inverter circuit 4 is used.

In the motor drive apparatus 60 equipped with the power conversion system 50, the inverter circuit 4 converts a DC voltage output from the converter circuit 1 into an AC voltage for motor driving and outputs the AC voltage. The motor 5 has its speed, torque, or rotor position controlled based on the AC voltage supplied from the inverter circuit 4. The inverter circuit 4 can even convert an AC voltage regenerated by the motor 5 into a DC voltage and return the DC voltage to the DC side, by appropriate control of the ON and OFF operations of the semiconductor switching elements.

The operation of the converter circuit according to the first embodiment will be described below.

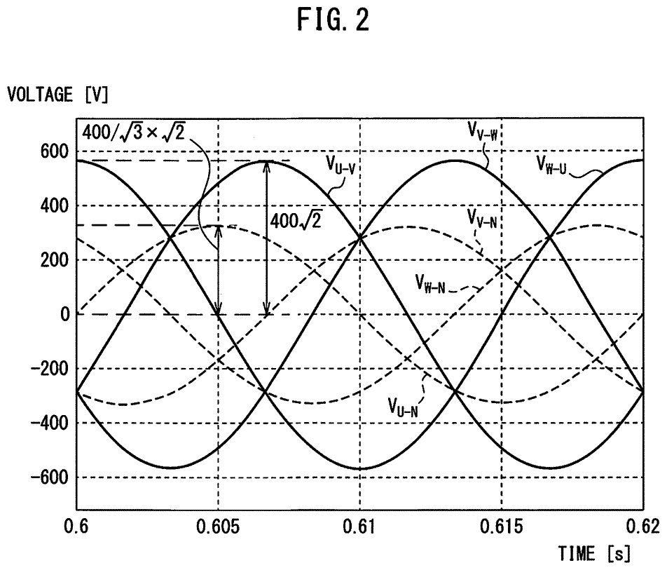

FIG. 2 is a graph representing the relationship between the line voltages and the phase voltages of a polyphase AC power supply. FIG. 2 illustrates, as an example, the waveforms of line voltages V_{U-V}, V_{V-W}, and V_{W-U} and phase voltages V_{U-N}, V_{V-N}, and V_{W-N} when the polyphase AC power supply 2 is implemented as a 400-V three-phase AC power supply. Since the effective values of the line voltages V_{U-V}, V_{V-W}, and V_{W-U} of the polyphase AC power supply 2 implemented as a 400-V three-phase AC power supply are 400[V], the maximum values (peak values) of the line voltages V_{U-V}, V_{V-W}, and V_{W-U} are about 566[V](=400×√2). Since the effective values of the phase voltages V_{U-N}, V_{V-N}, and V_{W-N} (i.e., the voltages of the respective phases as seen from the neutral point 6 of the polyphase AC power supply 2) are about 230[V](=400/√3), the maximum values (peak values) of the phase voltages V_{U-N}, V_{V-N}, and V_{W-N} are about 325[V](=400/√3×√2).

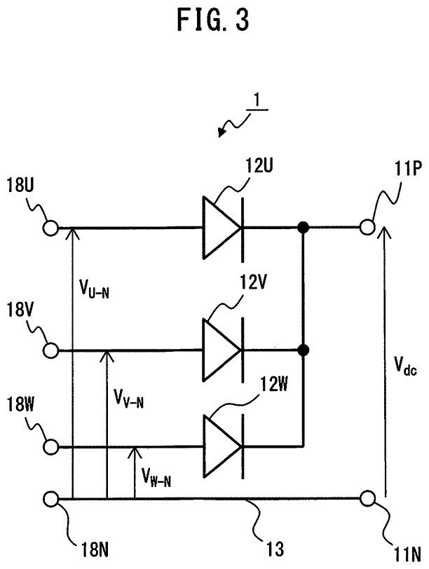

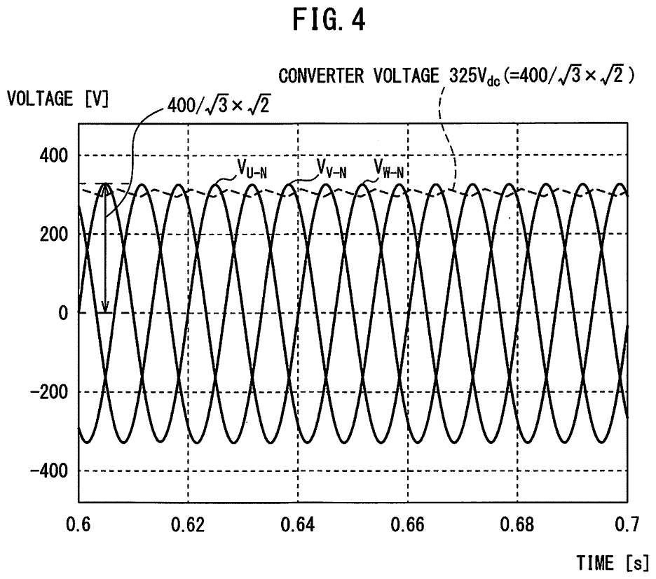

FIG. 3 is a circuit diagram for explaining the relationship between the AC input voltage and the DC output voltage in the converter circuit according to the first embodiment of the present disclosure. FIG. 4 is a graph illustrating an exemplary relationship between the DC output voltage of the converter circuit and the phase voltages of the polyphase AC power supply according to the first embodiment of the present disclosure. FIG. 4 illustrates, as an example, the waveforms of the phase voltages V_{U-N}, V_{V-N}, and V_{W-N}, and the waveform of a DC output voltage (converter voltage) V_{dc} appearing across the positive DC terminal 11P and the negative DC terminal 11N when the polyphase AC power supply 2 is implemented as a 400-V three-phase AC power supply.

As illustrated in FIG. 3, a U-phase voltage V_{U-N} is applied from the polyphase AC power supply 2 to the anode of the first diode 12U via the U-phase AC terminal 18U and the neutral AC terminal 18N. A V-phase voltage V_{V-N} is applied from the polyphase AC power supply 2 to the anode of the second diode 12V via the V-phase AC terminal 18V and the neutral AC terminal 18N. A W-phase voltage V_{W-N} is applied from the polyphase AC power supply 2 to the anode of the third diode 12W via the W-phase AC terminal 18W and the neutral AC terminal 18N. The positive DC terminal 11P is electrically connected to all of the cathode of the first diode 12U, the cathode of the second diode 12V, and the cathode of the third diode 12W. Therefore, a resultant voltage of the voltage output from the cathode of the first diode 12U, the voltage output from the cathode of the second diode 12V, and the voltage output from the cathode of the third diode 12W, with the neutral point 6 of the polyphase AC power supply 2 being defined to have a reference potential, appears across the positive DC terminal 11P and the negative DC terminal 11N. Since the first diode 12U, the second diode 12V, and the third diode 12W conduct power in the anode-to-cathode directions, a DC voltage V_{dc} of only positive polarity appears across the positive DC terminal 11P and the negative DC terminal 11N, although pulsating components remain due to a shift in phase between the phase voltages V_{U-N}, V_{V-N}, and V_{W-N} of the polyphase AC power supply 2. This means that the AC voltage of the polyphase AC power supply 2 can be rectified into a DC voltage by the first diode 12U, the second diode 12V, and the third diode 12W in the converter circuit 1. The DC voltage output across the positive DC terminal 11P and the negative DC terminal 11N of the converter circuit 1 takes a value slightly smaller than the maximum value of the phase voltage of the polyphase AC power supply 2. When, for example, the polyphase AC power supply 2 is implemented as a 400-V three-phase AC power supply, a voltage of about 325[V](=400/√3×√2) appears as a DC voltage.

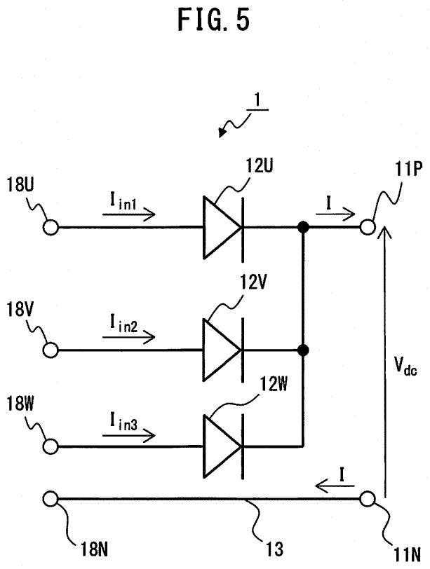

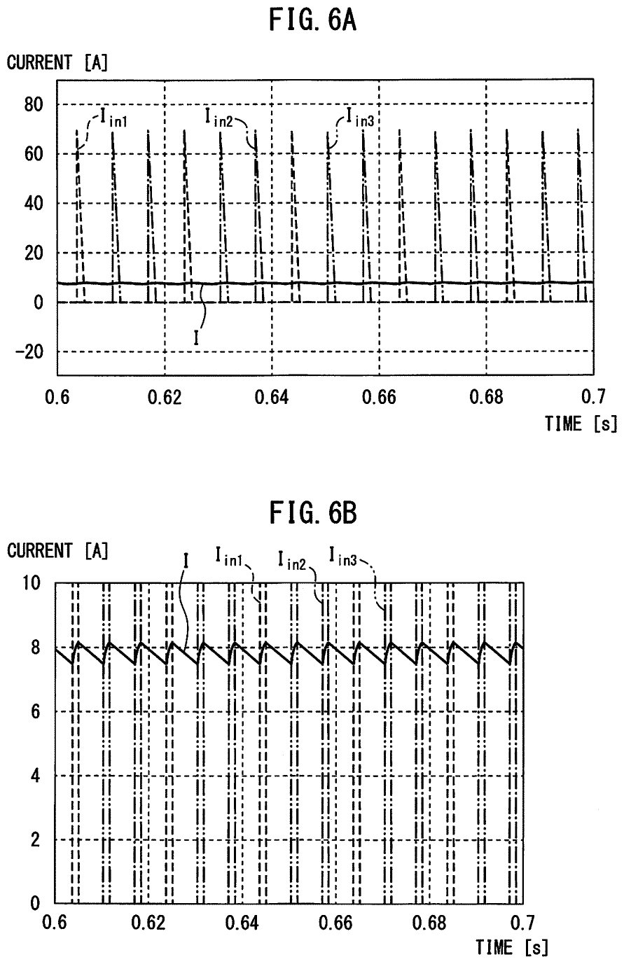

FIG. 5 is a circuit diagram for explaining the relationship between the AC input current and the DC output current in the converter circuit according to the first embodiment of the present disclosure. FIG. 6A is a chart illustrating an exemplary relationship between the DC output current waveform of the converter circuit and the AC input current waveform of the polyphase AC power supply according to the first embodiment of the present disclosure. FIG. 6B is a chart illustrating the details of FIG. 6A as enlarged in the direction of current.

As illustrated in FIG. 5, a U-phase AC current Iᵢₙ₁ flows from the polyphase AC power supply 2 into the anode of the first diode 12U via the U-phase AC terminal 18U. A V-phase AC current Iᵢₙ₂ flows from the polyphase AC power supply 2 into the anode of the second diode 12V via the V-phase AC terminal 18V. A W-phase AC current Iᵢₙ₃ flows from the polyphase AC power supply 2 into the anode of the third diode 12W via the W-phase AC terminal 18W. Since the first diode 12U, the second diode 12V, and the third diode 12W conduct power in the anode-to-cathode directions, a resultant current I of the current output from the cathode of the first diode 12U, the current output from the cathode of the second diode 12V, and the current output from the cathode of the third diode 12W is output from the positive DC terminal 11P. Accordingly, a fed-back current I flows into the negative DC terminal 11N. As illustrated in FIGS. 6A and 6B, a DC current I of only positive polarity is output from the converter circuit 1, although pulsating components remain due to a shift in phase between the currents Iᵢₙ₁, Iᵢₙ₂, and Iᵢₙ₃ entering from the polyphase AC power supply 2.

In this manner, the converter circuit 1 according to the first embodiment of the present disclosure can implement a rectification function for converting the AC voltage of the polyphase AC power supply 2 into a DC voltage. The converter circuit 1 includes diodes equal in number to the number of phases of the polyphase AC power supply 2 (in the example illustrated in FIG. 1, three diodes 12U, 12V, and 12W), and a connection portion 13 implemented as electrical wiring. In contrast to this, since the conventional converter circuit is embodied as a bridge circuit of diodes as for a diode rectifier circuit, and as a bridge circuit of semiconductor switching elements and diodes as for a PWM switching control rectifier circuit, it has a complicated structure, is large, and entails a high cost. The converter circuit 1 according to this embodiment has a simpler structure, is more compact, and costs less than in the conventional example. In some countries or regions, a single-phase AC voltage (i.e., an AC voltage of only one phase) may be extracted from a three-phase AC power supply and rectified to obtain a DC input voltage for an inverter circuit. In the converter circuit 1 according to this embodiment, since AC voltages obtained from all phases of the polyphase AC power supply (e.g., three phases as for a three-phase AC power supply) are rectified, a DC voltage with less pulsation can be obtained compared to the conventional example in which a single-phase AC voltage is rectified.

The DC output side of the converter circuit 1 serving as a component constituting the power conversion system 50 (motor drive apparatus 60) is electrically connected to the DC input side of the inverter circuit 4 via the capacitor 3, as illustrated in FIG. 1. A DC voltage equal to or lower than a DC input rated voltage is desirably input to the inverter circuit 4. Therefore, an inverter circuit 4 and a polyphase AC power supply 2 implemented as a three-phase AC power supply are preferably selected so that as a relation between the DC input rated voltage V_{dcrate}[V] of the inverter circuit 4 and the effective value V_{ac}[V] of the line voltage of the polyphase AC power supply 2 implemented as a three-phase AC power supply, we have the following equation (1):

$$\begin{matrix}[ Equation 1 ] & \\ {V}_{a c} \times \frac{1}{\sqrt{3}} \times \sqrt{2} < {V}_{d crate} & ( 1 )\end{matrix}$$

When, for example, a 400-V three-phase AC power supply is selected as the polyphase AC power supply 2, since V_{ac}=400[V], an inverter circuit 4 having a DC input rated voltage V_{dcrate} of about 325[V] or more is preferably selected.

As long as an inverter circuit 4 and a polyphase AC power supply 2 implemented as a three-phase AC power supply, which satisfy the above-mentioned equation (1), are selected, a power conversion system 50 including a converter circuit 1 including diodes (in the example illustrated in FIG. 1, three diodes 12U, 12V, and 12W), and a connection portion 13 implemented as electrical wiring, a capacitor 3, and an inverter circuit 4 can be configured, and a motor drive apparatus 60 including the power conversion system 50 can be configured.

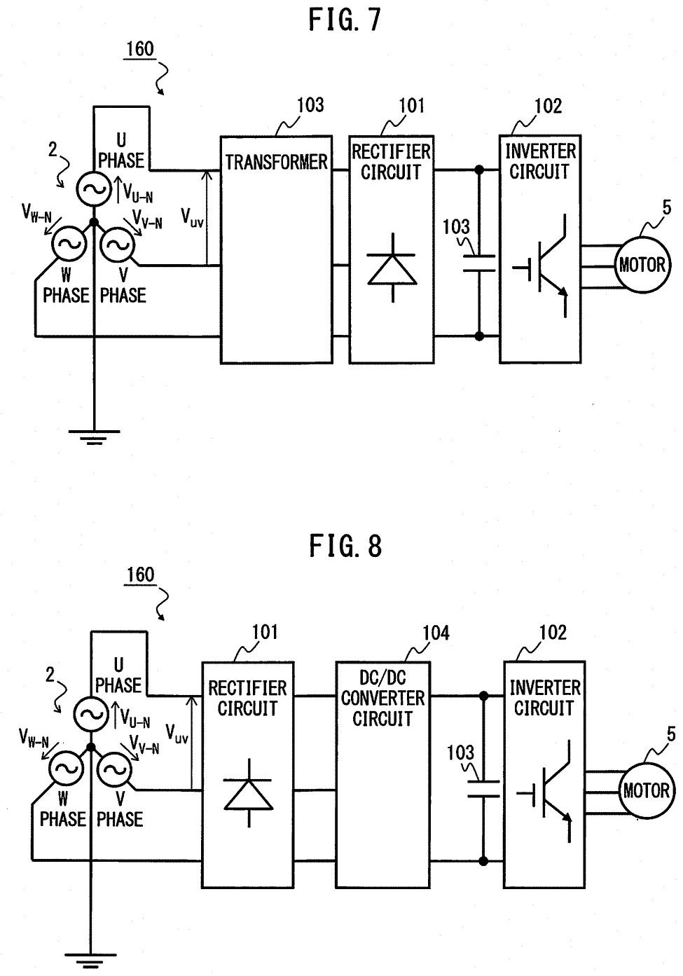

Conventional examples for comparison will be described herein with reference to FIGS. 7 and 8.

FIG. 7 is a block diagram depicting a motor drive apparatus according to a conventional example including a transformer. As illustrated in FIG. 7, in a conventional motor drive apparatus 160 for driving the motor 5 by the polyphase AC power supply 2, a transformer 103 is placed on the AC input side of a rectifier circuit (converter circuit) 101 and transforms an AC voltage input to the rectifier circuit 101 to step down the DC output voltage of the rectifier circuit 101 to be equal to or lower than the input rated voltage of an inverter circuit 102.

FIG. 8 is a block diagram depicting a motor drive apparatus according to another conventional example including a DC/DC converter circuit. As illustrated in FIG. 8, in another conventional motor drive apparatus 160 for driving the motor 5 by the polyphase AC power supply 2, a DC/DC converter circuit 104 (that is different from a converter circuit serving as a rectifier circuit) is placed on the DC output side of a rectifier circuit (converter circuit) 101 and lowers the DC output voltage of the rectifier circuit 101 by the DC/DC converter circuit 104 to obtain a voltage equal to or lower than the input rated voltage of an inverter circuit 102.

In this manner, in the motor drive apparatus according to the conventional example, a transformer 103 or a DC/DC converter circuit 104 is provided to set the

DC voltage input to the inverter circuit 102 to an input rated voltage or less. The transformer 103 and the DC/DC converter circuit 104 are physically large, have complicated circuitry, and naturally entail high costs. In contrast to this, according to the first embodiment of the present disclosure, since neither a transformer nor a DC/DC converter circuit may be preferably provided, a compact, low-cost power conversion system 50 and motor drive apparatus 60 having a simple structure can be achieved.

A converter circuit, a power conversion system, and a motor drive apparatus according to a second embodiment will be described next.

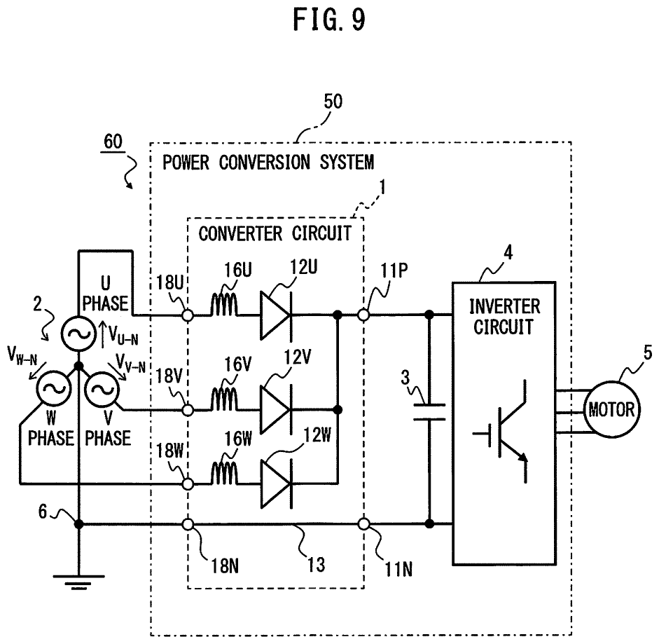

FIG. 9 is a block diagram depicting a converter circuit, a power conversion system, and a motor drive apparatus according to a second embodiment of the present disclosure. In the second embodiment, AC reactors 16U, 16V, and 16W are additionally interposed between the anodes of the diodes 12U, 12V, and 12W, respectively, of the converter circuit 1 and the respective phases of the polyphase AC power supply 2 in the first embodiment. In the example illustrated in FIG. 9, since the polyphase AC power supply 2 is implemented as a three-phase AC power supply, the first AC reactor 16U is electrically connected between the U-phase AC terminal 18U and the anode of the first diode 120. The second AC reactor 16V is electrically connected between the V-phase AC terminal 18V and the anode of the second diode 12V. The third AC reactor 16W is electrically connected between the W-phase AC terminal 18W and the anode of the third diode 12W. In this manner, providing AC reactors 16U, 16V, and 16W in correspondence with the respective phases of the polyphase AC power supply 2 makes it possible to reduce pulsation of a DC voltage output via the positive DC terminal 11P and the negative DC terminal 11N of the converter circuit 1. Since other circuit components are the same as those illustrated in FIG. 1, the same reference numerals denote the same circuit components, and a detailed description thereof will not be given.

A converter circuit, a power conversion system, and a motor drive apparatus according to a third embodiment will be described next.

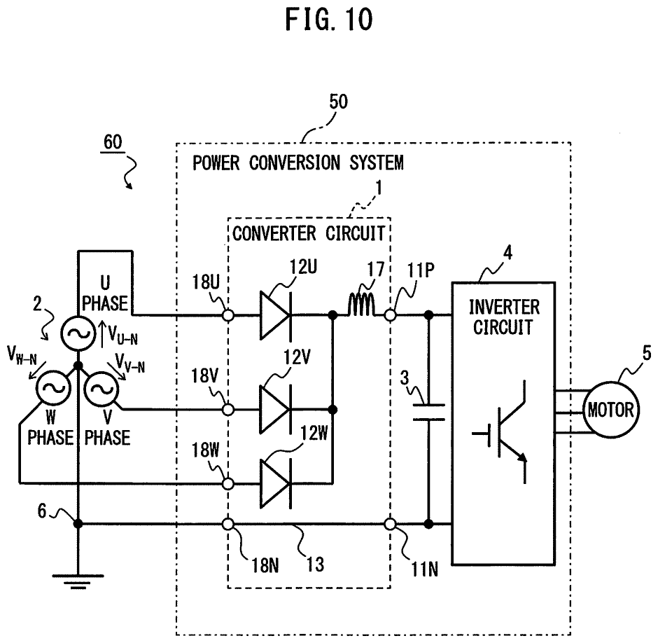

FIG. 10 is a block diagram depicting a converter circuit, a power conversion system, and a motor drive apparatus according to a third embodiment of the present disclosure. In the third embodiment, a DC reactor 17 is additionally interposed between the positive DC terminal 11P and the cathodes of all the diodes 12U, 12V, and 12W of the converter circuit 1 in the first embodiment. Providing a DC reactor 17 makes it possible to reduce pulsation of a DC voltage output via the positive DC terminal 11P and the negative DC terminal 11N of the converter circuit 1. Since other circuit components are the same as those illustrated in FIG. 1, the same reference numerals denote the same circuit components, and a detailed description thereof will not be given.

A converter circuit, a power conversion system, and a motor drive apparatus according to a fourth embodiment will be described next. The fourth embodiment is carried out as a combination of the above-described second and third embodiments.

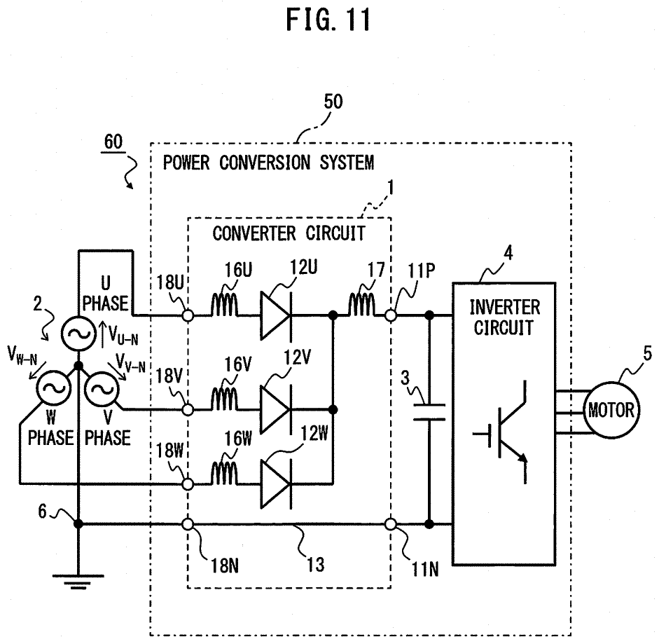

FIG. 11 is a block diagram depicting a converter circuit, a power conversion system, and a motor drive apparatus according to a fourth embodiment of the present disclosure.

In the example illustrated in FIG. 11, since a polyphase AC power supply 2 is implemented as a three-phase AC power supply, a converter circuit 1 is equipped with three AC reactors 16U, 16V, and 16W. The first AC reactor 16U is electrically connected between a U-phase AC terminal 18U and the anode of a first diode 12U. The second AC reactor 16V is electrically connected between a V-phase AC terminal 18V and the anode of a second diode 12V. The third AC reactor 16W is electrically connected between a W-phase AC terminal 18W and the anode of a third diode 12W. A DC reactor 17 is electrically connected between a positive DC terminal 11P and the cathodes of all the diodes 12U, 12V, and 12W. In this manner, providing AC reactors 16U, 16V, and 16W and a DC reactor 17 makes it possible to reduce pulsation of a DC voltage output via the positive DC terminal 11P and a negative DC terminal 11N of the converter circuit 1. Since other circuit components are the same as those illustrated in FIG. 1, the same reference numerals denote the same circuit components, and a detailed description thereof will not be given.

In this manner, with the converter circuit 1 according to any of the second to fourth embodiments, pulsation of a DC voltage output via the positive DC terminal 11P and the negative DC terminal 11N of the converter circuit 1 can be reduced more than in the first embodiment in which no reactor is placed on the AC or DC side of the converter circuit 1. Further, according to the second to fourth embodiments, since the inverter circuit 4 can convert a DC voltage with less pulsation into an AC voltage and output the AC voltage, a high-quality AC voltage with less harmonic components can be obtained compared to the first embodiment. Again, according to the second to fourth embodiments, in the motor drive apparatus 60, since the inverter circuit 4 can supply a high-quality AC voltage with less harmonic components to the motor 5 as a drive voltage, the controllability of the motor 5 can be improved more than in the first embodiment.

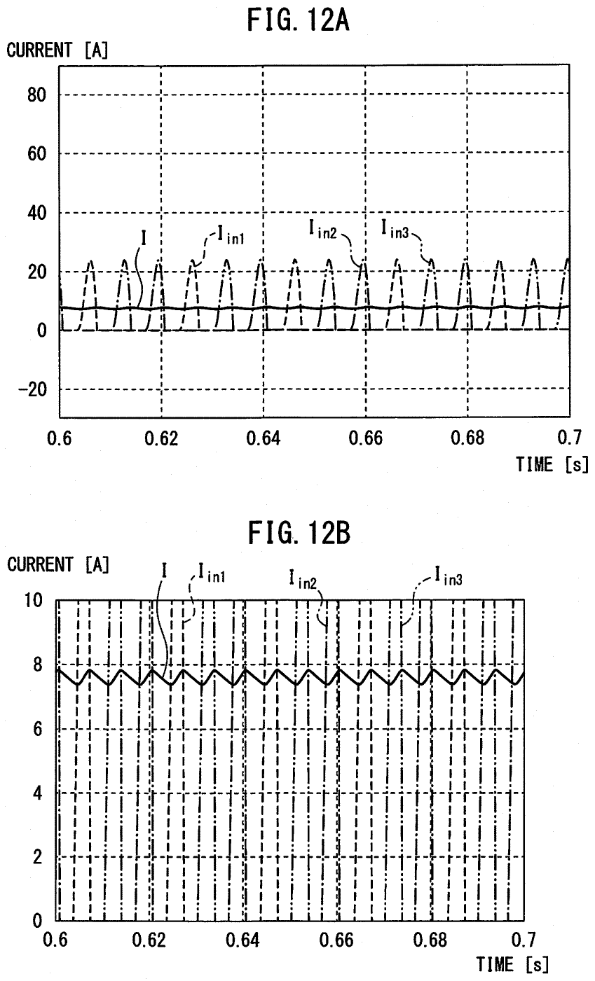

According to the second to fourth embodiments, compared to the first embodiment, while pulsation of the DC voltage output from the converter circuit 1 can be reduced more, the DC output current waveform of the converter circuit according to the third embodiment among these embodiments will be exemplified below. FIG. 12A is a chart illustrating an exemplary relationship between the DC output current waveform of the converter circuit and the AC input current waveform of the polyphase AC power supply according to the third embodiment of the present disclosure. FIG. 12B is a chart illustrating the details of FIG. 12A as enlarged in the direction of current. A comparison between the DC output current waveform of the converter circuit in the third embodiment illustrated in FIGS. 12A and 12B and that of the converter circuit in the first embodiment illustrated in FIGS. 6A and 6B reveals that pulsation of the DC voltage output from the converter circuit 1 can be reduced more in the third embodiment in which a DC reactor 17 is provided than in the first embodiment.

A converter circuit, a power conversion system, and a motor drive apparatus according to a fifth embodiment will be described next. In the fifth embodiment, so-called “power supply regeneration” for returning power regenerated by the motor 5 to the polyphase AC power supply 2 is enabled additionally to the first embodiment.

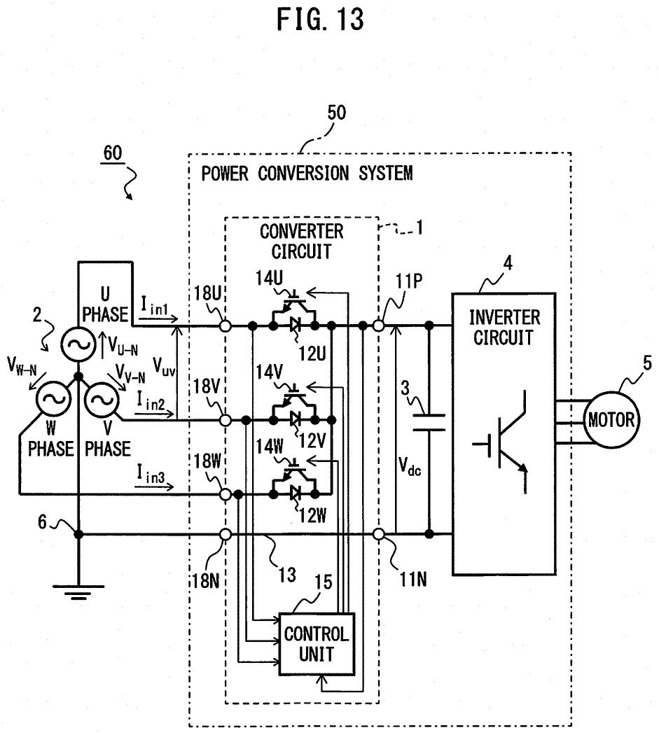

FIG. 13 is a block diagram depicting a converter circuit, a power conversion system, and a motor drive apparatus according to a fifth embodiment of the present disclosure.

A converter circuit 1 according to the fifth embodiment of the present disclosure includes, additionally to the converter circuit 1 according to the first embodiment, switches 14U, 14V, and 14W provided in correspondence with diodes 12U, 12V, and 12W, and a control unit 15 that controls the ON and OFF operation of each of the switches 14U, 14V, and 14W.

In the example illustrated in FIG. 13, since a polyphase AC power supply 2 is implemented as a three-phase AC power supply, the converter circuit 1 is equipped with three diodes 12U, 12V, and 12W, and three switches 14U, 14V, and 14W provided in correspondence with the diodes 12U, 12V, and 12W.

Each of the switches 14U, 14V, and 14W may be implemented as a semiconductor switching element or a mechanical switch as long as this switch conducts power in one direction in the ON state and conducts no power in the OFF state. An example of the semiconductor switching element may be an IGBT. Since the switches 14U, 14V, and 14W and the diodes 12U, 12V, and 12W are provided in correspondence with each other, an IGBT module including IGBTs and diodes packaged together may even be used.

The switches 14U, 14V, and 14W are electrically connected in parallel with the corresponding diodes 12U, 12V, and 12W, respectively, to set the directions in which the switches 14U, 14V, and 14W conduct power in the ON state opposite to those in which the corresponding diodes 12U, 12V, and 12W, respectively, conduct power. In other words, the first switch 14U is electrically connected in parallel with the first diode 12U to set the direction in which the first switch 14U conducts power in the ON state opposite to that in which the first diode 12U conducts power. The second switch 14V is electrically connected in parallel with the second diode 12V to set the direction in which the second switch 14V conducts power in the ON state opposite to that in which the second diode 12V conducts power. The third switch 14W is electrically connected in parallel with the third diode 12W to set the direction in which the third switch 14W conducts power in the ON state opposite to that in which the third diode 12W conducts power.

The control unit 15 controls the ON and OFF operation of each of the switches 14U, 14V, and 14W. More specifically, the control unit 15 compares AC voltages of the respective phases input via a U-phase AC terminal 18U, a V-phase AC terminal 18V, and a W-phase AC terminal 18W of the converter circuit 1 with a DC voltage output via a positive DC terminal 11P of the converter circuit 1, and determines that a power running state (non-regeneration state) has been set when the AC voltages of the respective phases are higher than the DC voltage, or determines that a regeneration state has been set when the AC voltages of the respective phases are lower than the DC voltage. When the control unit 15 determines that the regeneration state has been set, it controls the ON and OFF operations of the first switch 14U, the second switch 14V, and the third switch 14W, based on, e.g., the phases of the AC voltages of the respective phases input via the U-phase AC terminal 18U, the V-phase AC terminal 18V, and the W-phase AC terminal 18W of the converter circuit 1, and returns the power on the DC side of the converter circuit 1 to the polyphase AC power supply 2. When the control unit 15 determines that the regeneration state has been set, it returns the power on the DC side of the converter circuit 1 to the polyphase AC power supply 2 by, for example, turning on a switch (14U, 14V, or 14W) corresponding to a phase exhibiting a highest AC voltage of the polyphase AC power supply 2. In other words, a phase exhibiting a highest AC voltage among the respective phases of the AC voltages of the polyphase AC power supply 2 is detected, and a switch corresponding to the detected phase is turned on. More specifically, the first switch 14U is turned on when the AC voltage of the U phase is highest, the second switch 14V is turned on when the AC voltage of the V phase is highest, and the third switch 14W is turned on when the AC voltage of the W phase is highest.

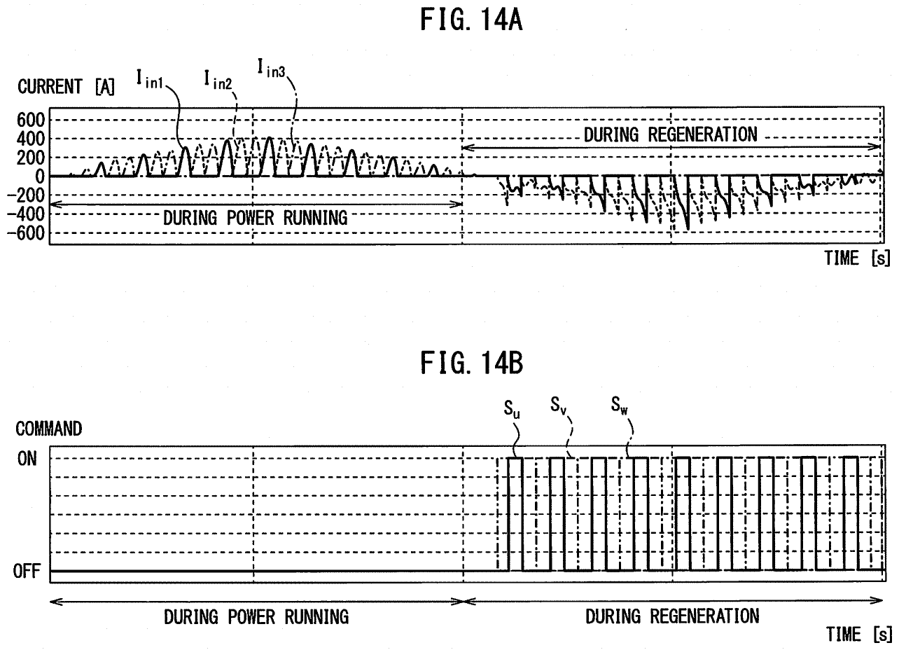

FIG. 14A is a chart representing the relationship between the waveforms of AC currents and ON and OFF commands issued by a control unit during power running and regeneration of the converter circuit in the fifth embodiment of the present disclosure, and depicts the waveforms of AC currents input to the converter circuit or output from the converter circuit. FIG. 14B is a chart representing the relationship between the waveforms of the AC currents and the ON and OFF commands issued by the control unit during power running and regeneration of the converter circuit in the fifth embodiment of the present disclosure, and depicts the ON and OFF commands issued by the control unit. Referring to FIG. 14A, a U-phase AC current Iᵢₙ₁ is indicated by a solid line, a V-phase AC current Iᵢₙ₂ is indicated by a broken line, and a W-phase AC current Iᵢₙ₃ is indicated by an alternate long and short dashed line. Referring to FIG. 14B, an ON and OFF command sent to the first switch 14U by the control unit 15 is indicated by a solid line, an ON and OFF command sent to the second switch 14V by the control unit 15 is indicated by a broken line, and an ON and OFF command sent to the third switch 14W by the control unit 15 is indicated by an alternate long and short dashed line.

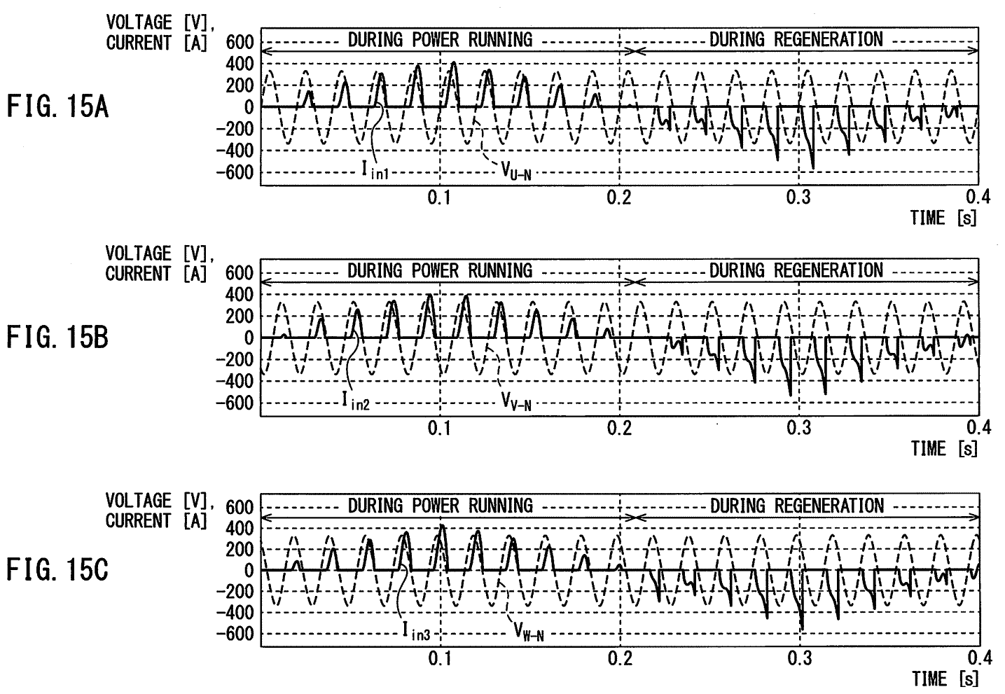

FIG. 15A is a chart representing the waveforms of an AC current and an AC voltage on the AC side of the converter circuit during power running and regeneration of the converter circuit in the fifth embodiment of the present disclosure, and depicts U-phase waveforms. FIG. 15B is a chart representing the waveforms of another AC current and another AC voltage on the AC side of the converter circuit during power running and regeneration of the converter circuit in the fifth embodiment of the present disclosure, and depicts V-phase waveforms. FIG. 15C is a chart representing the waveforms of still another AC current and still another AC voltage on the AC side of the converter circuit during power running and regeneration of the converter circuit in the fifth embodiment of the present disclosure, and depicts W-phase waveforms. Referring to FIGS. 15A, 15B, and 15C, AC currents are indicated by solid lines, and AC voltages are indicated by broken lines.

As illustrated in FIGS. 14A and 14B and FIGS. 15A, 15B, and 15C, during power running, since the control unit 15 outputs an OFF command to all of the first switch 14U, the second switch 14V, and the third switch 14W, and all of the U-phase AC current Iᵢₙ₁, the V-phase AC current Iᵢₙ₂, and the W-phase AC current Iᵢₙ₃ are positive, these AC currents flow into the converter circuit 1 to output DC voltages from the converter circuit 1 via the diodes 12U, 12V, and 12W. During regeneration, the control unit 15 outputs an ON command to the switch 14U, 14V, or 14W corresponding to a phase exhibiting a highest AC voltage of the polyphase AC power supply 2, to allow a DC current to flow into the converter circuit 1 to output AC currents from the converter circuit 1 via the switches 14U, 14V, and 14W. As a result, obviously, during regeneration, all of the U-phase AC current Iᵢₙ₁, the V-phase AC current Iᵢₙ₂, and the W-phase AC current Iᵢₙ₃ are negative, i.e., AC currents flow from the converter circuit 1 to the polyphase AC power supply 2.

The control unit 15 in the fifth embodiment may be constructed in, e.g., software program form, or may be constructed as a combination of various electronic circuits and a software program. When the control unit 15 is constructed in software program form, the function of the control unit 15 can be implemented by causing an arithmetic processing unit such as a DSP or an FPGA mounted in the power conversion system 50 to operate in accordance with the software program. When the power conversion system 50 is mounted in the motor drive apparatus 60, the function of the control unit 15 can be implemented by causing an arithmetic processing unit such as a DSP or an FPGA mounted in the motor drive apparatus 60 to operate in accordance with the software program. Alternatively, the control unit 15 may be implemented as a semiconductor integrated circuit in which a software program for implementing the function of the control unit 15 is written.

According to the above-described fifth embodiment, a compact, low-cost converter circuit 1, power conversion system 50, and motor drive apparatus 60 that have a simple structure and are capable of power supply regeneration can be achieved. The fifth embodiment may even be carried out in combination with any of the second to fourth embodiments.

According to one aspect of the present disclosure, a compact, low-cost converter circuit, a power conversion system, and a motor drive apparatus having a simple structure can be attained.

1. A converter circuit for converting an alternating-current voltage input from a polyphase alternating-current power supply into a direct-current voltage and outputting the direct-current voltage, the circuit comprising:
a positive direct-current terminal and a negative direct-current terminal configured to output the direct-current voltage;
a plurality of diodes each having an anode electrically connected to a corresponding phase of the polyphase alternating-current power supply, and all having cathodes electrically connected to the positive direct-current terminal; and
a connection portion electrically connecting a neutral point of the polyphase alternating-current power supply and the negative direct-current terminal to each other.

2. The converter circuit according to claim 1, further comprising:
a plurality of switches configured to conduct power in one direction in an ON state and conduct no power in an OFF state, each of the plurality of switches being electrically connected in parallel with a corresponding one of the plurality of diodes to set a direction in which the each of the switches conducts power in the ON state opposite to a direction in which the corresponding one of the diodes conducts power; and
a control unit configured to control an ON and OFF operation of each of the plurality of switches.

3. The converter circuit according to claim 1, further comprising a plurality of alternating-current reactors each interposed between the anode of a corresponding one of the plurality of diodes and a corresponding phase of the polyphase alternating-current power supply.

4. The converter circuit according to claim 1, further comprising a direct-current reactor interposed between the positive direct-current terminal and the cathodes of all the plurality of diodes.

5. A power conversion system comprising:
the converter circuit according to claim 1;
a capacitor interposed between the positive direct-current terminal and the negative direct-current terminal; and
an inverter circuit that is electrically connected to the converter circuit via the capacitor, and configured to convert the direct-current voltage output from the converter circuit into an alternating-current voltage and outputs the alternating-current voltage.

6. A motor drive apparatus comprising the power conversion system according to claim 5, p1 wherein the inverter circuit converts the direct-current voltage output from the converter circuit into an alternating-current voltage for motor driving and outputs the alternating-current voltage.
